(19) United States
(12) Patent Application Publication
(10) Pub. No.: US 2016/0358137 A1
(43) Pub. Date: Dec. 8, 2016

(54) PAYMENT SYSTEM, PAYMENT DEVICE, TRANSACTION TERMINAL, PAYMENT MANAGEMENT METHOD AND PROGRAM

(71) Applicant: NS SOLUTIONS CORPORATION, Tokyo (JP)

(72) Inventor: Shinichiro RYU, Tokyo (JP)

(21) Appl. No.: 15/117,609

(22) PCT Filed: Feb. 2, 2015
(86) PCT No.: PCT/JP2015/052883

§ 371 Date: Aug. 9, 2016

(30) Foreign Application Priority Data
Feb. 13, 2014 (JP) 2014-025893

(51) Int. Cl. G06Q 20/10; G06F 17/30; H04L 29/06; G06Q 20/40

(52) U.S. Cl. CPC G06Q 20/10; G06Q 20/4014; G06F 17/30952; H04L 63/0823; G06Q 2220/00

(57) ABSTRACT

A payment system includes a first transaction terminal and a second transaction terminal which make a transaction, and a payment device which manages payments. The first transaction terminal has a first communication unit which transmits part of a digital certificate of the first transaction terminal to the second transaction terminal via a first communication path. The payment device has: a communication unit which receives the part of the digital certificate of the first transaction terminal from the first transaction terminal, and receives part of a digital certificate of the second transaction terminal and the part of the digital certificate of the first transaction terminal from the second transaction terminal, via a second communication path different from the first communication path; and an authentication unit which performs authentication of the first transaction terminal and the second transaction terminal based on the parts of the respective digital certificates of the first transaction terminal and the second transaction terminal.

### TECHNICAL FIELD

The present invention relates to a payment system, a payment device, a transaction terminal, a payment management method and a program.

### BACKGROUND ART

Digital certificates have hitherto been used for payment in transactions, such as purchase of merchandise. The digital certificates are certificates used for preventing forgery of data or identity theft, and the like on the Internet. As a technique related to the digital certificates, Patent Literature 1 discloses a technique to include credit payment information in a digital certificate, and to perform processes of personal authentication and payment at the same time, so as to shorten a processing time for authentication and payment.

### CITATION LIST

### Patent Literature

Patent Literature 1: Japanese Laid-open Patent Publication No. 2009-205501

### SUMMARY OF INVENTION

### Technical Problem

However, in the related technique, there has been a problem that a digital certificate can be stolen and used in an unauthorized manner in middle of transmission to a payment device which performs authorization of digital certificate, and the like.

The present invention has been made in view of such problems, and has an object to prevent leak of data by unauthorized access to a communication path.

### Solution to Problem

Thus, according to the present invention, there is provided a payment system including a first transaction terminal, a second transaction terminal and a payment device. The first transaction terminal makes a transaction. The second transaction terminal makes a transaction. The payment device manages payments. The first transaction terminal has a first communication unit which transmits part of a digital certificate of the first transaction terminal to the second transaction terminal via a first communication path. The payment device has: a communication unit which receives the part of the digital certificate of the first transaction terminal from the first transaction terminal, and receives part of a digital certificate of the second transaction terminal and the part of the digital certificate of the first transaction terminal from the second transaction terminal, via a second communication path different from the first communication path; and an authentication unit which performs authentication of the first transaction terminal and the second transaction terminal based on the part of the digital certificate of the first transaction terminal and the part of the digital certificate of the second transaction terminal, respectively.

### Advantageous Effects of Invention

According to the present invention, leak of data through unauthorized access to a communication path can be prevented.

### BRIEF DESCRIPTION OF DRAWINGS

FIG. 1 is a diagram illustrating a payment system.

FIG. 2 is a diagram illustrating a hardware configuration of a store terminal.

FIG. 3 is a flowchart illustrating digital certificate issuance processing.

FIG. 4 is a diagram for explaining processing to extract part of a digital certificate.

FIG. 5A is a diagram for explaining array change processing.

FIG. 5B is a diagram for explaining the array change processing.

FIG. 6 is a diagram illustrating different reading directions.

FIG. 7 is a diagram illustrating an example of an encryption table group.

FIG. 8 is a diagram illustrating an example of a management table.

FIG. 9 is a sequence diagram illustrating payment processing.

FIG. 10 is a sequence diagram illustrating payment processing according to a second embodiment.

### DESCRIPTION OF EMBODIMENTS

Hereinafter, embodiments of the present invention will be described based on drawings.

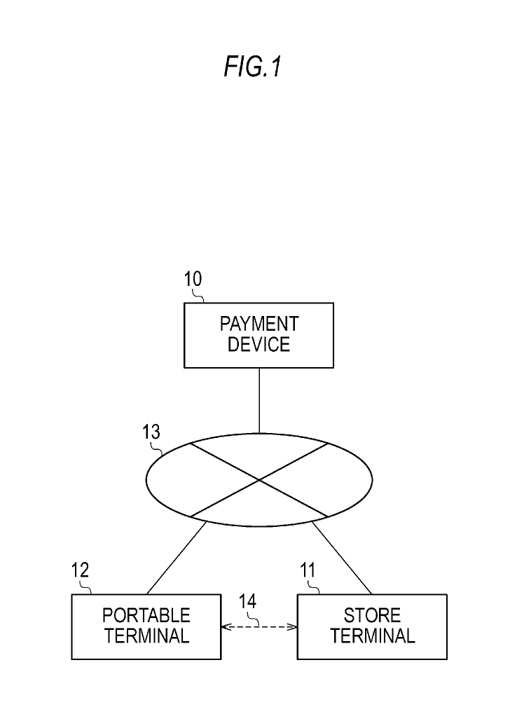

FIG. 1 is an overall diagram of a payment system according to this embodiment. The payment system has a payment device 10 which manages payment, a store terminal 11 performing a transaction, such as purchase of merchandise, and a portable terminal 12 held by a user, which is a transaction partner of the store terminal. Here, the store terminal 11 and the portable terminal 12 are examples of a transaction terminal which performs a transaction.

The payment device 10, the store terminal 11, and the portable terminal 12 are capable of communicating in a wireless or wired manner via a network 13, such as the Internet. Moreover, the store terminal 11 and the portable terminal 12 are capable of performing interactive communication via ultrasonic communication 14. Here, the communication path of the ultrasonic communication 14 and the communication path via the network 13 are an example of a first communication path and an example of a second communication path, respectively. Note that the communication method between the store terminal 11 and the portable terminal 12 is not limited to that of the embodiment, and may be a short-distance wireless communication, such as infrared data communication or Bluetooth (registered trademark), as another example.

The store terminal 11 and the portable terminal 12 store digital certificates issued in advance from the payment device 10. The digital certificates are used by the payment device 10 for authenticating the store terminal 11 and the portable terminal 12 in a transaction between the store terminal 11 and the portable terminal 12.

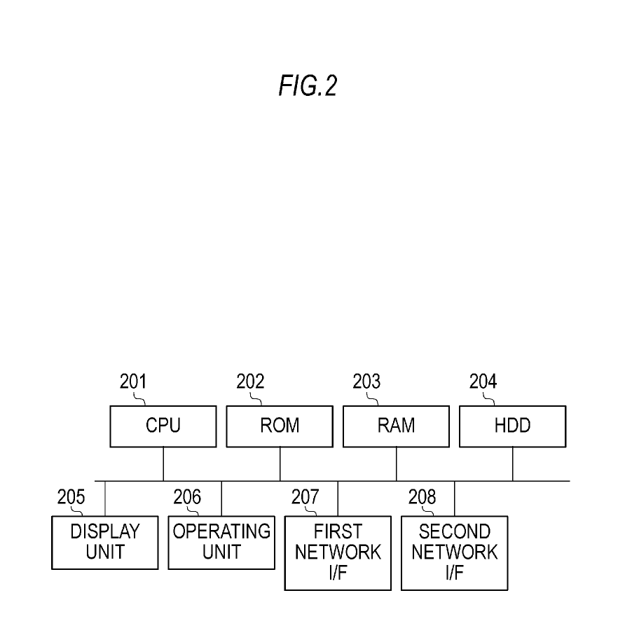

FIG. 2 is a diagram illustrating a hardware configuration of the store terminal 11. The store terminal 11 has a CPU 201, a ROM 202, a RAM 203, an HDD 204, a display unit 205, an operating punit 206, a first network I/F 207, and a second network I/F 208.

The CPU 201 reads a control program stored in the ROM 202 and then performs various types of processing. The RAM 203 is used as a main memory and a temporary storage area, such as a work area, of the CPU 201. The HDD 204 stores various data and information, such as image data and various programs. The display unit 205 displays various types of information. The operating unit 206 accepts various operations performed by the user. The first network I/F 207 performs communication processing with an external device by the ultrasonic communication 14. The second network I/F 208 performs communication processing with an external device via the network 13.

The functions and processing of the store terminal 11 which will be described later are implemented by the CPU 201 reading a program stored in the ROM 202 or the HDD 204 and then executing this program.

Note that the hardware configuration of the portable terminal 12 is the same as the hardware configuration of the store terminal 11. Further, the hardware configuration of the payment device 10 is substantially the same as the hardware configuration of the store terminal 11, but the payment device 10 need not have the first network I/F 207 and/or the like. The functions and processing of the store terminal 11 and the payment device 10 which will be described later are implemented by the CPU 201 of each device reading a program stored in the ROM 202 or the HDD 204 and then executing this program.

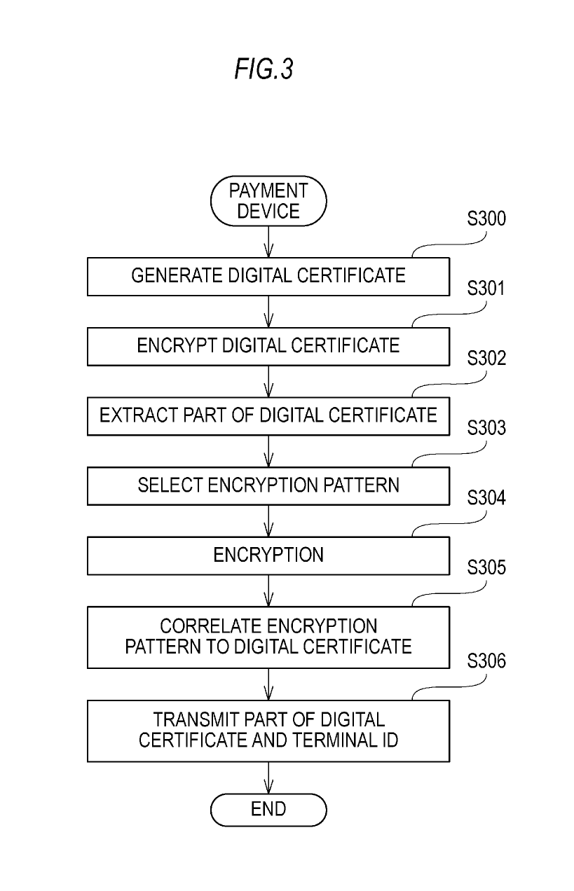

FIG. 3 is a flowchart illustrating digital certificate issuance processing by the payment device 10. Upon accepting an issuance request for a digital certificate from the store terminal 11, the CPU 201 of the payment device 10 issues a digital certificate of the store terminal 11 in the digital certificate issuance processing. Similarly, upon accepting an issuance request for a digital certificate from the portable terminal 12, the CPU 201 of the payment device 10 issues a digital certificate of the portable terminal 12 in the digital certificate issuance processing. Hereinafter, taking an example of the case of accepting the issuance request from the store terminal 11, the digital certificate issuance processing will be described. In the digital certificate issuance processing, in S300, in accordance with the issuance request, the CPU 201 of the payment device 10 assigns a terminal ID to the store terminal 11 that is the requester, and generates a digital certificate including the assigned terminal ID. Here, the terminal ID is information for identifying a terminal. The terminal ID is information that further allows identifying the type, which is whether the terminal is the store terminal 11 or the portable terminal 12.

In addition, as another example, the issuance of digital certificate may also be performed by a CA (Certificate Authority) station for example. In this case, the CPU 201 of the payment device 10 in S300 obtains a digital certificate from a private CA station or a public CA station instead of generating the digital certificate.

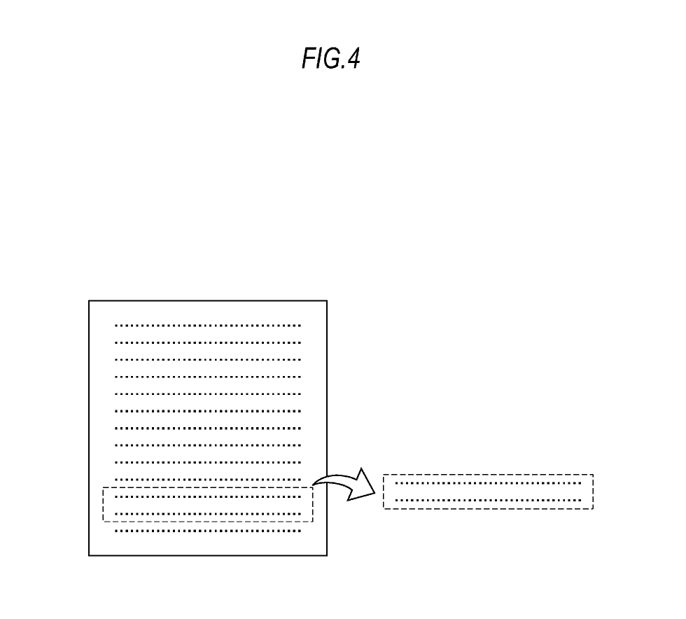

Next, in S301, the CPU 201 of the payment device 10 encrypts the generated digital certificate. Next, in S302, the CPU 201 of the payment device 10 extracts part of the digital certificate as illustrated in FIG. 4. The position and size of the area to be extracted is, for example, set in advance in the ROM 202 or the like. In addition, as another example, the position and size of the area to be extracted may be changed every time S302 is executed. Although one area is extracted from the digital certificate in this embodiment, moreover, the number of areas to be extracted is not limited to that in this embodiment and may be one position or plural positions in the digital certificate. Further, the size of the area to be extracted is not limited to that in this embodiment. However, it is preferred that a signature be contained in the area to be an extraction target.

Next, in S303, the CPU 201 of the payment device 10 selects an encryption table to be applied to part of the extracted digital certificate. Next, in S304, the CPU 201 of the payment device 10 encrypts part of the digital certificate by using the selected encryption table. More specifically, the CPU 201 of the payment device 10 divides data to be encrypted, that is, the part of the digital certificate into a plurality of blocks (hereinafter referred to as target blocks), and replaces the arrangement order of data in the target block based on a magic square. The CPU 201 of the payment device 10 further inserts a dummy block in the array of the target block. Moreover, the rules for changing the array order and the position of inserting the dummy block are specified in the encryption table.

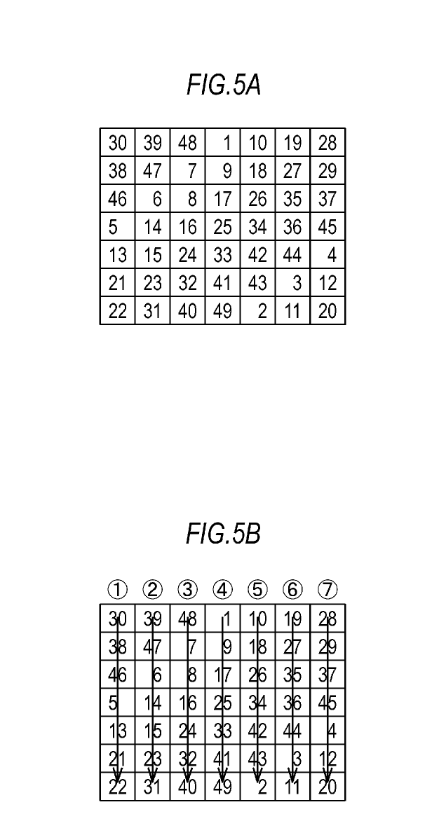

Here, array change processing of changing the array order of data in the target block will be described. In this embodiment, the CPU 201 of the payment device 10 divides encryption target data into 40-bit target blocks. FIG. 5A is a diagram illustrating an example of a magic square used in the array change processing. The width of the magic square illustrated in FIG. 5A is 7, and the magic square has 49 (7×7) cells. In each of the cells, one of numbers 1 to 49 is disposed so that the total sums of the numbers arrayed in vertical, horizontal, and diagonal directions are all equal. The CPU 201 of the payment device 10 disposes data in the target block bit by bit in the cells in this order of numbers. Moreover, when the number of target blocks is less than the number of cells of the magic square, the CPU 201 of the payment device 10 disposes dummy data in remaining cells. When the target block is 40-bit, the CPU 201 of the payment device 10 disposes dummy data in cells of 41 to 49.

Furthermore, the CPU 201 of the payment device 10 changes the array of the target data by sequentially reading bit data disposed in the cells along a direction indicated by arrows in FIG. 5B. In the examples illustrated in FIG. 5A and FIG. 5B, each bit in the target block from number 1 to number 49 including the dummy data are changed to an order in which number 30 is the first, which is followed by 38, 46, 5, and so on.

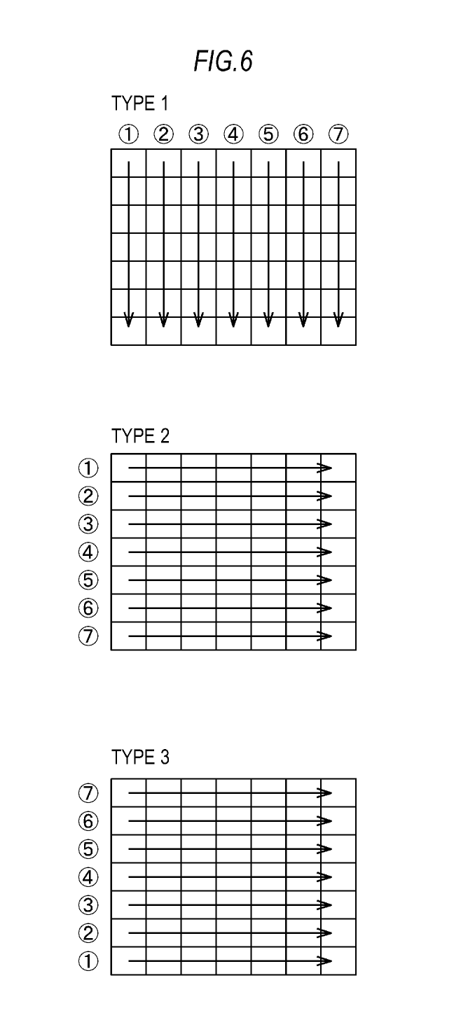

Note that the numeric values in the cells illustrated in FIG. 5A are examples. When the arrangement of these numeric values is different, the same target data are changed to be in a different array order. Furthermore, even when a magic square in which the same numeric values are disposed is used, if the reading direction of bit data disposed in the cells is different, the same target data are changed to be in a different array order. FIG. 6 is a diagram illustrating different reading directions. Type 1 is to read from the top left in a downward direction, and subsequently read the second column from the left in the downward direction. Type 2 is to read from the top left in a rightward direction, and subsequently read the second row from the top in the rightward direction. Type 3 is to read from the bottom left in a rightward direction, and subsequently read the second row from the bottom in the rightward direction.

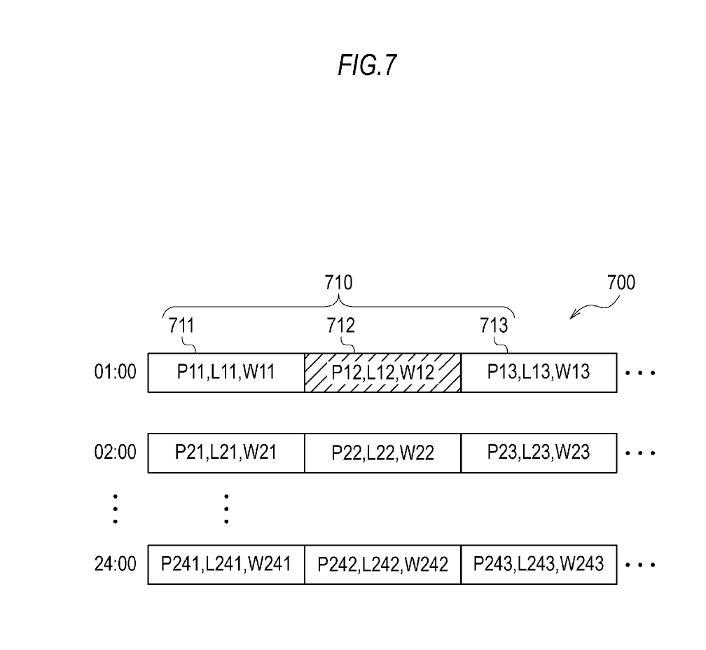

FIG. 7 is a diagram illustrating an example of an encryption table group 700 stored in the RAM 203 or the like of the payment device 10. The encryption table group 700 has a plurality of encryption tables. The encryption table group 700 according to this embodiment has 24 different encryption tables correlated to the time of day, such as 01:00, 02:00, and so on. The encryption tables hold information indicating the rules for changing the data array of encryption target data.

The encryption table 710 at 01:00 has a plurality of pieces of block information 711, 712, 713, and so on. Similarly, each encryption table has a plurality of pieces of block information. Each piece of block information holds information related to encryption of each target block. Each piece of block information has Pab, Lab, and Wab. Here, P represents a pattern, L represents a valid bit length of target block, and W represents a width (odd number) of magic square. Index a represents a time of the table, and index b represents the order from the head of the target block.

Note that in units of block information, different values for the pattern P, the valid bit length L of target block, and the width W of magic square may be set in every block information. However, at least one of the pattern P, the valid bit length L of target block, and the width W of magic square contained in each encryption table need not be different in all the pieces of block information. One encryption table may have a plurality of identical pieces of block information. Further, a plurality of encryption tables may have the same block information.

Further, the plurality of encryption tables just need to be one for changing the same encryption target data to different data in the entire table. Specifically, in the plurality of encryption tables, arrays of block information contained in the respective encryption tables just need to be different.

The pattern P illustrates a disposition of cells of a magic square and a reading pattern. Further, in this embodiment, the valid bit length L of the target block is set to 40-bit, and correspondingly the width of the magic square is set to 7. Note that the width W of magic square and the valid bit length L of target block satisfy the relation of (Expression 1).

L<W² (Expression 1)

On the other hand, in the dummy data, the width W of magic square and the valid bit length L of target block which satisfy (Expression 2) are set. Thus, the CPU 201 of the payment device 10 can distinguish the dummy block and the target block from the width W of magic square and the valid bit length L of target block.

L>W² (Expression 2)

For example, the block information 711 is relate to the target block, and L11 and W11 satisfy the relation of L11<W11². On the other hand, the block information 712 is related to the dummy block, and L12 and W12 do not satisfy the relation of L12<W12².

Referring back to FIG. 3, in S303, the CPU 201 of the payment device 10 selects an encryption table correlated to the time of the processing of S303 from the encryption table group 700 illustrated in FIG. 7. For example, when the time of the processing is 13:20, the CPU 201 of the payment device 10 selects the encryption table correlated to 13:00. Here, it is assumed that 13:00 of the encryption table means to include 60 minutes from 13:00 to 13:59. Moreover, in S304, the CPU 201 encrypts the encryption target data by referring to the selected encryption table, changing the data array in the target block obtained from the encryption target data, and inserting dummy data.

Thus, in this embodiment, the CPU 201 of the payment device 10 selects the encryption table corresponding to the time of the processing from the 24 encryption tables correlated to times. That is, the CPU 201 of the payment device 10 periodically changes the encryption table to select according to the time.

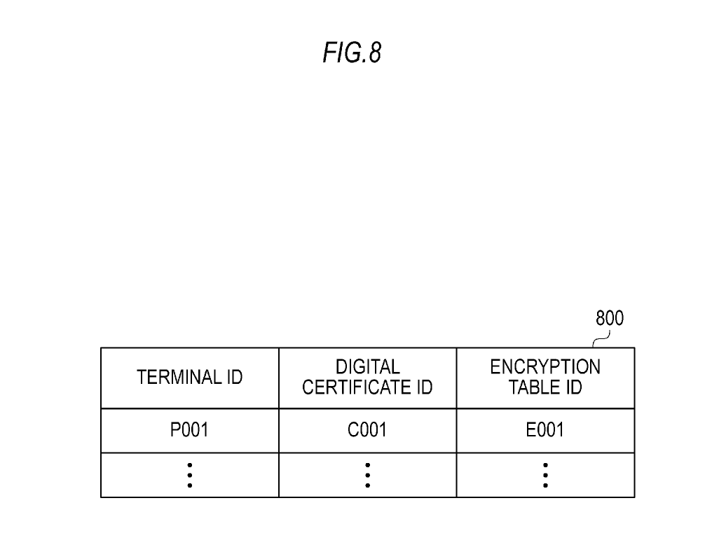

Next, in S305, the CPU 201 of the payment device 10 correlates a table ID for identifying the encryption table that is referred to in the encryption processing (S304) to the terminal ID of the requester of the digital certificate, and stores the table ID in the management table. FIG. 8 is a diagram illustrating an example of the management table. The management table 800 stores terminal IDs, digital certificate IDs, and encryption table IDs in correlation. The management table 800 is stored in, for example, the RAM 203 or the like of the payment device 10. Here, the processing of S305 is an example of encryption table management processing which correlates the transaction terminal (store terminal 11 or store terminal 11) corresponding to a digital certificate as an encryption target to the encryption table selected for the digital certificate as an encryption target.

Next, in S306, the CPU 201 of the payment device 10 transmits the part of the digital certificate after being encrypted and the terminal ID of the terminal of the requester to the terminal of the requester (store terminal 11 or portable terminal 12), thereby finishing the digital certificate issuance processing. Moreover, the CPU 201 of the terminal (store terminal 11 or portable terminal 12) which received the part of the digital certificate and so on, when it receives the part of the digital certificate after being encrypted, stores the received part of the digital certificate after being encrypted in the RAM 203 or the like of the terminal.

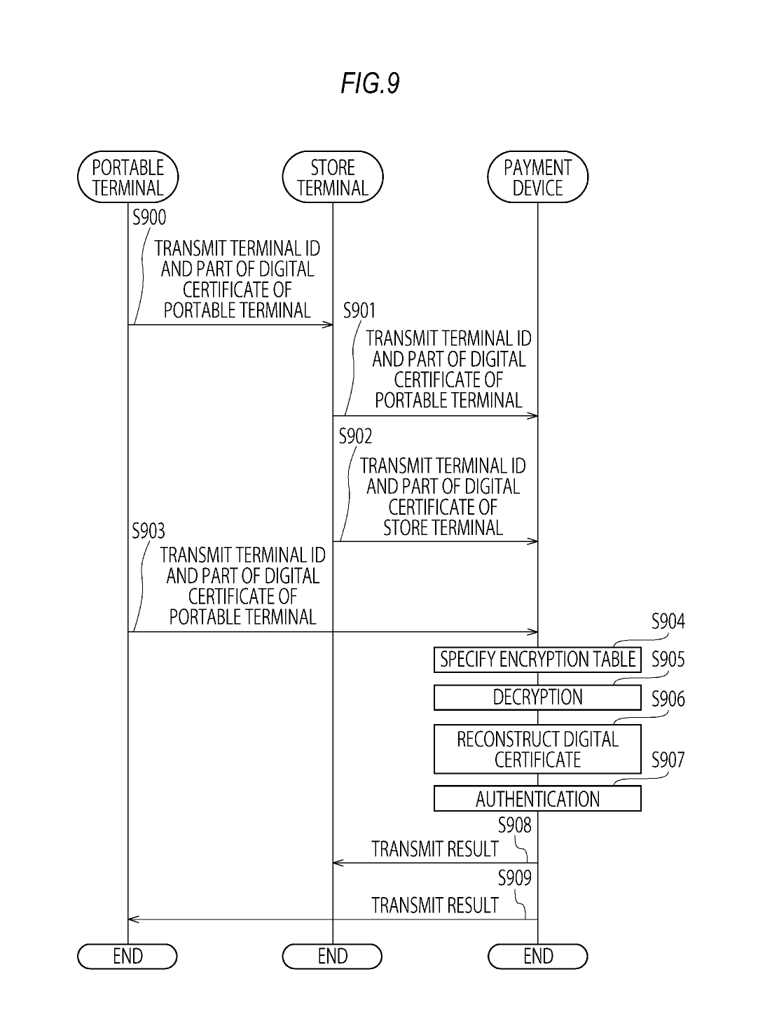

FIG. 9 is a sequence diagram illustrating payment management processing in the payment system. When a transaction occurs, such as when the user of the portable terminal 12 makes a payment for an article in the store where the store terminal 11 is installed, the user of the store terminal 11 and the user of the portable terminal 12 perform an authentication operation. When the authentication operation is performed, payment processing is started.

That is, in S900, in accordance with the authentication operation by the user of the portable terminal 12, the CPU 201 of the portable terminal 12 reads the terminal ID of the portable terminal 12 and part of the digital certificate of the portable terminal 12 from the RAM 203 or the like. Then, the CPU 201 of the portable terminal 12 transmits the read terminal ID and the read part of the digital certificate of the portable terminal 12 to the store terminal 11 which is the transaction partner via the ultrasonic communication 14. In addition, as another example, the CPU 201 of the portable terminal 12 may encrypt the part of the digital certificate, and in S900, the CPU 201 may transmit the part of the digital certificate after being encrypted to the store terminal 11.

Next, in S901, the CPU 201 of the store terminal 11 transmits the terminal ID and the part of the digital certificate of the portable terminal 12 which are received from the portable terminal 12 to the payment device 10 via the network 13. Next, in S902, in accordance with the authentication operation by the user of the store terminal 11, the CPU 201 of the store terminal 11 reads the terminal ID of the store terminal 11 and the part of the digital certificate of the store terminal 11 from the RAM 203 or the like. Then, the CPU 201 of the store terminal 11 transmits the read terminal ID and the read part of the digital certificate of the store terminal 11 to the payment device 10 via the network 13. Moreover, in S903, the CPU 201 of the portable terminal 12 transmits the terminal ID and the part of the digital certificate of the portable terminal 12 to the payment device 10 via the network 13.

Note that the processing of S901 and the processing of S902 are each performed independently, and the order of executing them is not limited to that in the embodiment. Moreover, similarly, the processing of S900 and the processing of S903 are each performed independently, and the order of executing them is not limited to that in the embodiment.

Upon reception of the terminal ID and the part of the digital certificate of the store terminal 11, the CPU 201 of the payment device 10 starts processing of S904. In S904, by referring to the management table, the CPU 201 identifies the encryption table used for encrypting the part of the digital certificate of the store terminal 11 based on the terminal ID of the store terminal 11. Next, in S905, the CPU 201 of the payment device 10 decrypts the part of the digital certificate of the store terminal 11 based on the encryption table identified based on the terminal ID of the store terminal 11 in S904. Next, in S906, the CPU 201 of the payment device 10 uses the part of the digital certificate after being decrypted to reconstruct the digital certificate of the store terminal 11.

Similarly, upon reception of the terminal ID and the part of the digital certificate of the portable terminal 12, in S904 the CPU 201 of the payment device 10 identifies the encryption table used for encrypting the digital certificate of the portable terminal 12. Next, in S905 the CPU 201 of the payment device 10 decrypts the part of the digital certificate of the portable terminal 12 based on the encryption table identified based on the terminal ID of the portable terminal 12 in S904. Next, in S906, the CPU 201 of the payment device 10 uses the part of the digital certificate after being decrypted to reconstruct the digital certificate of the portable terminal 12. Note that, since the CPU 201 of the payment device 10 receives the part of the digital certificate of the portable terminal 12 from each of the store terminal 11 and the portable terminal 12, two digital certificates of the portable terminal 12 are reconstructed in the processing of S904 to S906.

Next, in S907, the CPU 201 of the payment device 10 authenticates the store terminal 11 and the portable terminal 12 based on the digital certificate of the store terminal 11 and the two digital certificates of the portable terminal 12 which are reconstructed in S905. Next, in S908, the CPU 201 of the payment device 10 transmits the authentication result to the portable terminal 12, and in S909 the CPU 201 of the payment device 10 transmits the authentication result to the store terminal 11. Note that the store terminal 11 and the portable terminal 12 are permitted to make a transaction when the authentication succeeds, or not permitted to make a transaction when the authentication fails.

As described above, in the payment system according to this embodiment, the information to be transmitted from the store terminal 11 and the portable terminal 12 to the payment device 10 is only part of their digital certificates. Therefore, it is possible to avoid a situation that all the digital certificates are stolen by a third person in middle of transmission to the payment device 10.

Further, the store terminal 11 obtains part of the digital certificate of the portable terminal 12 from the portable terminal 12, and transmits this part to the payment device 10. Therefore, in order for the payment device 10 to succeed in its authentication, the store terminal 11 needs to securely transmit the part of the digital certificate of the transaction partner to the payment device 10, which strengthens the security of the transaction processing.

Moreover, since the payment device 10 encrypts part of the digital certificate by using the magic square, and also periodically changes the encryption table to be used for encryption, leak of digital certificates can be prevented.

In a first modification example of the payment system according to the embodiment, the CPU 201 of the payment device 10 may periodically update a conversion table group. Specifically, when a certain time passes, the CPU 201 of the payment device 10 generates a new encryption table group based on the date and time at the time of passage, that is, respective values of year, month, day, minutes, and seconds. Then, the CPU 201 of the payment device 10 updates the encryption table group stored in the RAM 203 or the like to a new encryption table group. Moreover, also when falseness is detected, the CPU 201 of the payment device 10 may update the encryption table group automatically. More specifically, in the event of detection of, for example, accesses from several geographically remote locations in a time zone that does not realistically allow traveling therebetween, unauthorized use of the payment device 10 and/or the transaction terminals (store terminal 11 and portable terminal 12), such as consecutive purchases of expensive goods, or suspicious use that is possibly unauthorized use, the CPU 201 of the payment device 10 generates a new encryption table group based on the date and time it is detected, and updates the encryption table group stored in the RAM 203 or the like to the new encryption table group.

### Second Embodiment

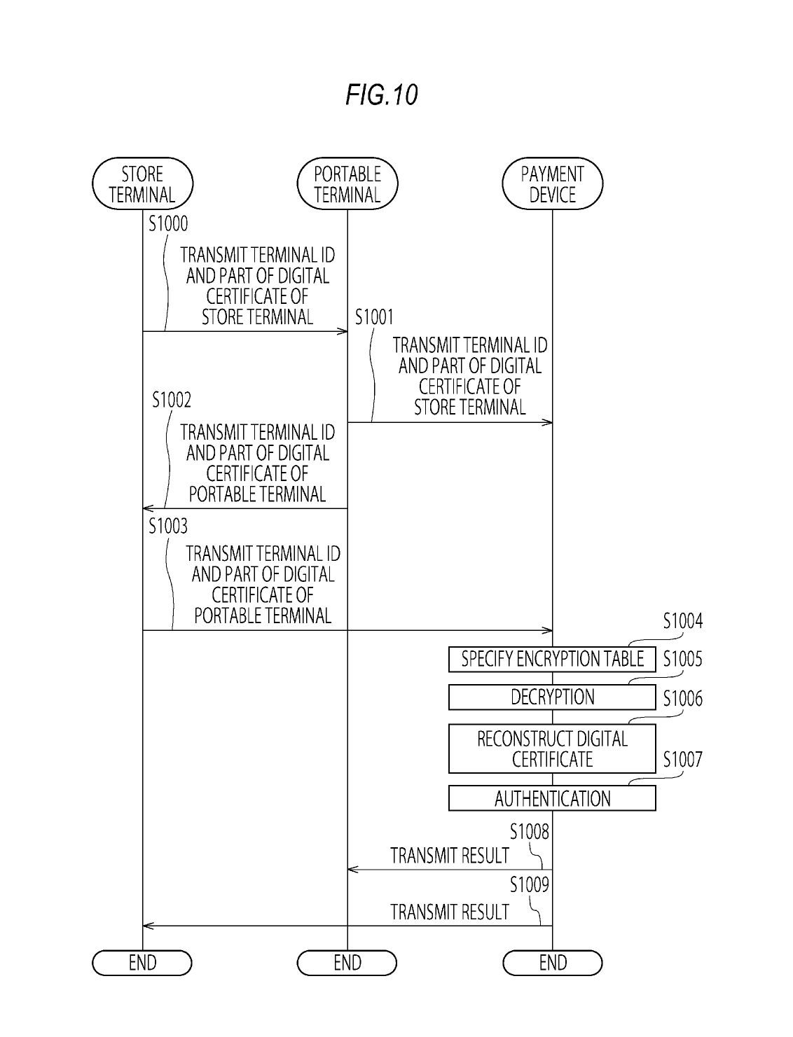

FIG. 10 is a sequence diagram illustrating payment management processing in a payment system according to a second embodiment. In S1000, in accordance with an authentication operation by the user of the store terminal 11, the CPU 201 of the store terminal 11 reads the terminal ID of the store terminal 11 and part of the digital certificate of the store terminal 11 from the RAM 203 or the like. Then, the CPU 201 of the store terminal 11 transmits the read terminal ID and the read part of the digital certificate of the store terminal 11 to the portable terminal 12 which is a transaction partner via the ultrasonic communication 14. Next, in S1001, the CPU 201 of the portable terminal 12 transmits the terminal ID and the part of the digital certificate of the store terminal 11 which are received from the store terminal 11 to the payment device 10 via the network 13.

On the other hand, in S1002, in accordance with the authentication operation by the user of the portable terminal 12, the CPU 201 of the portable terminal 12 reads the terminal ID of the portable terminal 12 and part of the digital certificate of the portable terminal 12 from the RAM 203 or the like. Then, the CPU 201 of the portable terminal 12 transmits the read terminal ID and the read part of the digital certificate of the portable terminal 12 to the store terminal 11 which is a transaction partner via the ultrasonic communication 14. Next, in S1003, the CPU 201 of the store terminal 11 transmits the terminal ID and the part of the digital certificate of the portable terminal 12 which are received from the portable terminal 12 to the payment device 10 via the network 13.

As described above, the store terminal 11 and the portable terminal 12 as transaction terminals transmit their own terminal IDs and parts of digital certificates to the partner terminals (portable terminal 12 and store terminal 11) which are the transaction partners. Further, the store terminal 11 and the portable terminal 12 as transaction terminals each receive the terminal ID and the part of the digital certificate of the partner terminal from the partner terminal. By the processing as above, the store terminal 11 and the portable terminal 12 complete exchange of the part of the digital certificate from each other. Note that the processing of S1000 and S1001 and the processing of S1002 and S1003 are performed independently from each other, and this order of execution is not limited to that in this embodiment.

Upon reception of the terminal ID and the part of the digital certificate of the store terminal 11 from the portable terminal 12, the CPU 201 of the payment device 10 starts processing of S1004. In S1004, by referring to the management table, the CPU 201 identifies the encryption table used for encrypting the part of the digital certificate of the store terminal 11 based on the terminal ID of the store terminal 11. Next, in S1005, the CPU 201 of the payment device 10 decrypts the part of the digital certificate of the store terminal 11 based on the encryption table identified based on the terminal ID of the store terminal 11 in S1004. Next, in S1006, the CPU 201 of the payment device 10 uses the part of the digital certificate after being decrypted to reconstruct the digital certificate of the store terminal 11.

Similarly, upon reception of the terminal ID and the part of the digital certificate of the portable terminal 12 from the store terminal 11, in S1004 the CPU 201 of the payment device 10 identifies the encryption table used for encrypting the digital certificate of the portable terminal 12. Next, in S1005 the CPU 201 of the payment device 10 decrypts the part of the digital certificate of the portable terminal 12 based on the encryption table identified based on the terminal ID of the portable terminal 12 in S1004. Next, in S1006, the CPU 201 of the payment device 10 uses the part of the digital certificate after being decrypted to reconstruct the digital certificate of the portable terminal 12.

Next, in S1007, the CPU 201 of the payment device 10 authenticates the store terminal 11 and the portable terminal 12 based on the digital certificate of the store terminal 11 and the digital certificate of the portable terminal 12 which are reconstructed in S1005. Next, in S1008, the CPU 201 of the payment device 10 transmits the authentication result to the portable terminal 12, and in S1009 the CPU 201 of the payment device 10 transmits the authentication result to the store terminal 11. Note that the store terminal 11 and the portable terminal 12 are permitted to make a transaction when the authentication succeeds, or not permitted to make a transaction when the authentication fails.

As described above, in the payment system according to this embodiment, the information to be transmitted from the store terminal 11 and the portable terminal 12 to the payment device 10 is only part of their digital certificates. Therefore, it is possible to avoid a situation that all the digital certificates are stolen by a third person in middle of transmission to the payment device 10.

Further, parts of digital certificates are exchanged between the store terminal 11 and the portable terminal 12 which are making a transaction, and the parts of the digital certificates of the transaction partners are transmitted to the payment device 10. Therefore, in order for the payment device 10 to succeed in its authentication, each of the store terminal 11 and the portable terminal 12 needs to securely transmit the part of the digital certificate of the transaction partner to the payment device 10, which strengthens the security of the transaction processing.

### Other Embodiments

Further, the present invention can also be implemented by executing the following processing. Specifically, software (program) that implements the functions of the above-described embodiments is supplied to a system or a device via a network or one of various types of recording media. Then, a computer (or CPU, MPU, or the like) of the system or the device executes processing to read and run the program.

As described above, the above-described embodiments enable to carry out safer payment by using digital certificates. Further, the above embodiments also enable to prevent leak of data by unauthorized access to communication paths.

Preferred embodiments of the present invention have been described above. However, the present invention is not limited to such specific embodiments, and various modifications and changes can be made within the range of the gist of the present invention which is described in the claims.

1. A payment system comprising a first transaction terminal, a second transaction terminal and a payment device, the first transaction terminal making a transaction, the second transaction terminal making a transaction, the payment device managing payments;
wherein the first transaction terminal comprises a first communication unit which transmits part of a digital certificate of the first transaction terminal to the second transaction terminal via a first communication path, and
the payment device comprises:
a communication unit which receives the part of the digital certificate of the first transaction terminal from the first transaction terminal, and receives part of a digital certificate of the second transaction terminal and the part of the digital certificate of the first transaction terminal from the second transaction terminal, via a second communication path different from the first communication path; and
an authentication unit which performs authentication of the first transaction terminal and the second transaction terminal based on the part of the digital certificate of the first transaction terminal and the part of the digital certificate of the second transaction terminal, respectively.

2. A payment system comprising a first transaction terminal, a second transaction terminal and a payment device, the first transaction terminal making a transaction, the second transaction terminal making a transaction, the payment device managing payments;
wherein the first transaction terminal and the second transaction terminal each comprise a communication unit, the communication unit of the first transaction terminal and the communication unit of the second transaction terminal transmitting, via a first communication path, part of a digital certificate of the first transaction terminal and part of a digital certificate of the second transaction terminal to the second transaction terminal and the first transaction terminal, respectively, the first transaction terminal and the second transaction terminal being transaction partners, and
the payment device comprises:
a communication unit which receives the part of the digital certificate of the second transaction terminal from the first transaction terminal and receives the part of the digital certificate of the first transaction terminal from the second transaction terminal, via a second communication path different from the first communication path; and
an authentication unit which authenticates the first transaction terminal and the second transaction terminal based on the part of the digital certificate of the first transaction terminal and the part of the digital certificate of the second transaction terminal, respectively.

3. The payment system according to claim 1,
wherein the communication units of the first transaction terminal and the second transaction terminal transmit the part of the digital certificate of the first transaction terminal and the pare of the digital certificate of the second transaction terminal via the first communication path using a short-distance wireless communication.

4. The payment system according to claim 1,
wherein the communication unit of the payment device transmits at least the part of the digital certificate of the first transaction terminal to the first transaction terminal and transmits at least the part of the digital certificate of the second transaction terminal to the second transaction terminal,
the first transaction terminal and the second transaction terminal each further comprise a storage unit which stores at least the part of the digital certificate received from the payment device, and
the communication units of the first transaction terminal and the second transaction terminal transmit the part of the digital certificate stored in the storage units of the first transaction terminal and the part of the digital certificate stored in the storage units of the second transaction terminal, respectively.

5. The payment system according to claim 1,
wherein the payment device further comprises an encryption unit which encrypts the part of the digital certificate of the first transaction terminal and the part of the digital certificate of the second transaction terminal,
the communication unit of the payment device transmits the part of the digital certificate of the first transaction terminal to the first transaction terminal, and transmits the part of the digital certificate of the second transaction terminal to the second transaction terminal, the part of the digital certificate of the first transaction terminal being encrypted, the part of the digital certificate of the second transaction terminal being encrypted,
the payment device further comprises a decryption unit which decrypts the parts of the digital certificates, the parts of the digital certificates being received from the first transaction terminal and the second transaction terminal, respectively, and
the authentication unit of the payment device performs the authentication based on the part of the digital certificates of the first transaction terminal after being decrypted and the part of the digital certification of the second transaction terminal after being decrypted.

6. The payment system according to claim 5,
wherein the encryption unit divides the digital certificate into a plurality of blocks, changes a data array in each of the blocks, and inserts a dummy block in arrays of the plurality of blocks, to thereby encrypts the digital certificate.

7. The payment system according to claim 5, wherein the payment device further comprises:
a storage unit which stores a plurality of encryption tables which indicate rules of change of data arrays in blocks;
a selection unit which selects an encryption table used for encryption from the plurality of encryption tables; and
an encryption table management unit which correlates the transaction terminal to the encryption table, the transaction terminal corresponding to a digital certificate of a target of encryption, the encrypted table being selected for the digital certificate of the target,
the encryption unit performs encryption based on the encryption table selected by the selection unit, and
the decryption unit performs decryption based on the encryption table correlated to the transaction terminal corresponding to the digital certificate.

8. The payment system according to claim 7, wherein the payment device further comprises an update unit which periodically updates the plurality of encryption tables stored in the storage unit.

9. The payment system according to claim 8, wherein the update unit updates the encryption tables stored in the storage unit when falseness is detected.

10. A payment device which manages payments, comprising:
a communication unit which receives part of a digital certificate of a second transaction terminal from a first transaction terminal, and receives part of a digital certificate of the first transaction terminal from the second transaction terminal, the first transaction terminal making a transaction, the second transaction terminal being a transaction partner of the first transaction terminal, the part of a digital certificate of the second transaction terminal being received by the first transaction terminal from the second transaction terminal, the part of a digital certificate of the first transaction terminal being received by the second transaction terminal from the first transaction terminal; and
an authentication unit which performs authentication of the first transaction terminal and the second transaction terminal based on the part of the digital certificate of the first transaction terminal and the part of the digital certificate of the second transaction terminal, respectively.

11. A payment device which manages payments, comprising:
a communication unit which receives part of a digital certificate of a first transaction terminal from the first transaction terminal, and receives part of the digital certificate of the first transaction terminal and part of a digital certificate of the second transaction terminal from the second transaction terminal, the first transaction terminal making a transaction, the second transaction terminal being a transaction partner of the first transaction terminal, the part of the digital certificate of the first transaction terminal being received from the first transaction terminal by the second transaction terminal; and
an authentication unit which performs authentication of the first transaction terminal and the second transaction terminal based on the part of the digital certificate of the first transaction terminal and the part of the digital certificate of the second transaction terminal, respectively.

12. A transaction terminal used for transaction, comprising:
a first communication unit which transmits part of a digital certificate of the transaction terminal to a partner terminal via a first communication path, and receives part of a digital certificate of the partner terminal from the partner terminal via the first communication path; and
a second communication unit which transmits the part of the digital certificate of the partner terminal to a payment device via a second communication path different from the first communication path, the payment device managed payments of transaction.

13. A payment management method executed by a payment system comprising a first transaction terminal, a second transaction terminal and a payment device, the first transaction terminal making a transaction, the second transaction terminal making a transaction, the payment device managing payment, the payment management method comprising:
a first communication step in which the first transaction terminal and the second transaction terminal transmit, via a first communication path, part of a digital certificate of the first transaction terminal and part of a digital certificate of the second transaction terminal to the second transaction terminal and the first transaction terminal, respectively, the first transaction terminal and the second transaction terminal being transaction partners;
a second communication step in which the payment device receives the part of the digital certificate of the second transaction terminal from the first transaction terminal and receives the part of the digital certificate of the first transaction terminal from the second transaction terminal, via a second communication path different from the first communication path; and
an authentication step in which the payment device authenticates the first transaction terminal and the second transaction terminal based on the part of the digital certificate of the first transaction terminal and the part of the digital certificate of the second transaction terminal, respectively.

14. A payment management method executed by a payment system comprising a first transaction terminal a second transaction terminal and a payment device, the first transaction terminal making a transaction, the second transaction terminal making a transaction, the payment device managing payments, the payment management method comprising:
a first communication step in which the first transaction terminal transmits part of a digital certificate of the first transaction terminal to the second transaction terminal via a first communication path;
a second communication step in which the payment device receives the part of the digital certificate of the first transaction terminal from the first transaction terminal, and receives part of a digital certificate of the second transaction terminal and the part of the digital certificate of the first transaction terminal from the second transaction terminal, via a second communication path different from the first communication path; and
an authentication step in which the payment device performs authentication of the first transaction terminal and the second transaction terminal based on the parts of the digital certificates of the first transaction terminal and the parts of the digital certificate of the second transaction terminal, respectively.

15. A payment management method executed by a payment device which manages payments, the payment management method comprising:
a communication step of receiving, from a first transaction terminal, part of a digital certificate of a second transaction terminal from the second transaction terminal, and receiving, from the second transaction terminal, part of a digital certificate of the first transaction terminal, the first transaction terminal making a transaction, the second transaction terminal being a transaction partner of the first transaction terminal, the part of a digital certificate of the second transaction terminal being received by the first transaction terminal from the second transaction terminal, the part of a digital certificate of the first transaction terminal being received by the second transaction terminal from the first transaction terminal; and
an authentication step of performing authentication of the first transaction terminal and the second transaction terminal based on the parts of the digital certificate of the first transaction terminal and the part of the digital certificate of the second transaction terminal.

16. A payment management method executed by a payment device which manages payments, the payment management method comprising:
a communication step of receiving part of a digital certificate of a first transaction terminal from the first transaction terminal, and receiving part of the digital certificate of the first transaction terminal and part of a digital certificate of the second transaction terminal from the second transaction terminal, the first transaction terminal making a transaction, the second transaction terminal being a transaction partner of the first transaction terminal, the part of the digital certificate of the first transaction terminal being received from the first transaction terminal by the second transaction terminal; and
an authentication step of performing authentication of the first transaction terminal and the second transaction terminal based on the part of the digital certificate of the first transaction terminal and the part of the digital certificate of the second transaction terminal.

17. A payment management method executed by a transaction terminal used for transaction, the payment management method comprising:
a first communication step of transmitting part of a digital certificate of the transaction terminal to a partner terminal via a first communication path, and receives part of a digital certificate of the partner terminal from the partner terminal via the first communication path; and
a second communication step of transmitting the part of the digital certificate of the partner terminal to a payment device via a second communication path different from the first communication path, the payment device managing payments of transaction.

18. A computer readable non-transitory recording medium with a program causing a computer to execute:
a communication step of receiving, from a first transaction terminal, part of a digital certificate of a second transaction terminal from the second transaction terminal, and receiving, from the second transaction terminal, part of a digital certificate of the first transaction terminal, the first transaction terminal making a transaction, the second transaction terminal being a transaction partner of the first transaction terminal, the part of a digital certificate of the second transaction terminal being received by the first transaction terminal from the second transaction terminal, the part of a digital certificate of the first transaction terminal being received by the second transaction terminal from the first transaction terminal; and
an authentication step of performing authentication of the first transaction terminal and the second transaction terminal based on the part of the digital certificate of the first transaction terminal and the part of the digital certificate of the second transaction terminal, respectively.

19. A computer readable non-transitory recording medium with a program causing a computer to execute:
a communication step of receiving part of a digital certificate of a first transaction terminal from the first transaction terminal, and receiving part of the digital certificate of the first transaction terminal and part of a digital certificate of the second transaction terminal from the second transaction terminal, the first transaction terminal making a transaction, the second transaction terminal being a transaction partner of the first transaction terminal, the part of the digital certificate of the first transaction terminal being received from the first transaction terminal by the second transaction terminal; and
an authentication step of performing authentication of the first transaction terminal and the second transaction terminal based on the part of the digital certificate of the first transaction terminal and the part of the digital certificate of the second transaction terminal, respectively.

20. A computer readable non-transitory recording medium with a program causing a computer to execute:
a first communication step of transmitting part of a digital certificate of the transaction terminal to a partner terminal via a first communication path, and receives part of a digital certificate of the partner terminal from the partner terminal via the first communication path; and
a second communication step of transmitting the part of the digital certificate of the partner terminal to a payment device via a second communication path different from the first communication path, the payment device managing payments of transaction.
